(19) United States
(12) Patent Application Publication
(10) Pub. No.: US 2006/0120459 A1
(43) Pub. Date: Jun. 8, 2006

(54) Method for coding vector refinement information required to use motion vectors in base layer pictures when encoding video signal and method for decoding video data using such coded vector refinement information

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/288,163

(22) Filed: Nov. 29, 2005

Related U.S. Application Data
(60) Provisional application No. 60/631,180, filed on Nov. 29, 2004.

(30) Foreign Application Priority Data
Mar. 28, 2005 (KR) 10-2005-0025410

(51) Int. Cl. H04N 11/04; H04N 7/12; H04N 11/02; H04B 1/66

(52) U.S. Cl. 375/240.17; 375/240.08; 375/240.16; 375/240.24

(57) ABSTRACT

A method for coding vector refinement information required to use motion vectors in base layer pictures when encoding a video signal and a method for decoding video data using the coded vector refinement information are provided. A value for vector refinement information of an image block present in a frame in an enhanced layer, which represents the difference between a position pointed to by a motion vector of the image block and a position pointed to by a scaled motion vector obtained by scaling a motion vector of a corresponding block in a temporally coincident frame in a bitstream of the base layer by half of the ratio of the enhanced layer picture size to the base layer picture size, is selected from 8 values allocated to 8 quarter-pixels surrounding the position pointed to by the scaled motion vector, and the vector refinement information having the selected value is recorded.

### PRIORITY INFORMATION

This application claims priority under 35 U.S.C. §119 on Korean Patent Application No. 10-2005-0025410, filed on Mar. 28, 2005, the entire contents of which are hereby incorporated by reference.

This application also claims priority under 35 U.S.C. §119 on U.S. Provisional Application No. 60/631,180, filed on Nov. 29, 2004; the entire contents of which are hereby incorporated by reference.

### BACKGROUND OF THE INVENTION

1. Field of the Invention

The present invention relates to scalable encoding and decoding of a video signal, and more particularly to a method for coding vector refinement information required to use motion vectors in base layer pictures when encoding a video signal according to a Motion Compensated Temporal Filtering (MCTF) scheme and a method for decoding video data using such coded vector refinement information.

2. Description of the Related Art

Scalable Video Codec (SVC) encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is an encoding scheme that has been suggested for use in the scalable video codec.

Although it is possible to represent low image-quality video by receiving and processing part of the sequence of pictures encoded in the scalable MCTF coding scheme, there is still a problem in that the image quality is significantly reduced if the bitrate is lowered. One solution to this problem is to provide an auxiliary picture sequence for low bitrates, for example, a sequence of pictures that have a small screen size and/or a low frame rate.

The auxiliary picture sequence is referred to as a base layer, and the main frame sequence is referred to as an enhanced or enhancement layer. Video signals of the base and enhanced layers have redundancy since the same video signal source is encoded into two layers. To increase the coding efficiency of the enhanced layer according to the MCTF scheme, one method converts each video frame of the enhanced layer into a predictive image based on a video frame of the base layer temporally coincident with the enhanced layer video frame. Another method codes motion vectors of a picture in the enhanced layer using motion vectors of a picture in the base layer temporally coincident with the enhanced layer picture. FIG. 1 illustrates a procedure for coding a picture in the enhanced layer using motion vectors of a temporally coincident picture in the base layer, and FIG. 2 illustrates how vector-related information is coded in the procedure.

The motion vector coding method illustrated in FIG. 1 is performed in the following manner. If the screen size of frames in the base layer is less than the screen size of frames in the enhanced layer, a base layer frame F1 temporally coincident with a current enhanced layer frame F10, which is to be converted into a predictive image, is enlarged to the same size as the enhanced layer frame. Here, motion vectors of macroblocks in the base layer frame are also scaled up by the same ratio as the enlargement ratio of the base layer frame.

Through motion estimation of each macroblock MB10 in the enhanced layer frame F10, a reference block of the macroblock MB10 is found, and a motion vector mv1 originating from the macroblock MB10 and extending to the found reference block is determined. The motion vector mv1 is compared with a scaled motion vector mvScaledBL1 obtained by scaling up a motion vector mvBL1 of a corresponding macroblock MB1 in the base layer frame F1, which covers an area in the base layer frame F1 corresponding to the macroblock MB10. If both the enhanced and base layers use macroblocks of the same size (for example, 16×16 macroblocks), a macroblock in the base layer covers a larger area in a frame than a macroblock in the enhanced layer. The motion vector mvBL1 of the corresponding macroblock MB1 in the base layer frame F1 is determined by a base layer encoder before the enhanced layer is encoded.

If the two motion vectors mv1 and mvScaledBL1 are identical, a value indicating that the motion vector mv1 of the macroblock MB10 is identical to the scaled motion vector mvScaledBL1 of the corresponding block MB1 in the base layer is recorded in a block mode of the macroblock MB10. Specifically, a BLFlag field in a header of the macroblock MB10 is set to 1, completing the recording of vector-related information as shown in FIG. 2 (S201).

However, even if the macroblock MB10 and the corresponding block MB 1 have motion vectors pointing to co-located areas in temporally coincident frames, the motion vectors may be slightly different due to different pointing accuracies if the size of a picture in the enhanced layer is different from that of the base layer. For example, if the size of a picture in the enhanced layer is four times that of the base layer, a 16×16 block in the enhanced layer covers ¼ (=½×½) of an image area covered by a 16×16 block in the base layer so that spatial resolution (i.e., pointing accuracy) of each of the x and y (i.e., vertical and horizontal) components of a vector in the enhanced layer is twice that of a motion vector (or a scaled motion vector) in the base layer. Specifically, as illustrated in FIG. 3, a motion vector mv1 in the enhanced layer can point to all quarter-pixels P(4 m+i,4n+j) (i, j=0, 1, 2, 3) located at the intersections of x and y-axis quarter-pixel lines which quarter the pitch of x and y-axis pixel lines, whereas a scaled one mvScaledBL1 of a motion vector in the base layer cannot point to all quarter-pixels, for example, can only point to quarter-pixels P(4m+i,4n+j)(i, j=0, 2) on even x and y-axis quarter-pixel lines.

Accordingly, when the motion vector mv1 of the macroblock MB10 points to a quarter-pixel on an odd x or y-axis quarter-pixel line in a reference picture including its reference block, the position of the quarter-pixel pointed to by the motion vector mv1 must differ from that pointed to by the scaled motion vector mvScaledBL1 by one quarter-pixel in the x or y axis as indicated by a shaded area A in FIG. 3. Such a small vector pointing difference must be compensated for in order to allow the scaled motion vector provided from the base layer to be used as the motion vector of the macroblock MB10. To accomplish this, a flag QRefFlag in the header of the macroblock MB10 is set to 1 and vector refinement information is additionally recorded therein (S202). The recorded vector refinement information is expressed as a vector, each of the x and y components of which may have 3 different values of +1, 0, and −1 to express three states so that the vector can express 9 different states.

If the vector difference (i.e., mv1−mvScaledBL1) exceeds the range of values (or the coverage) of the vector refinement information, the vector difference is directly coded, completing the recording of the vector-related information (S203).

In the above method for recording vector refinement information, x and y components of the values of vector refinement information are recorded independently of each other so that the x and y coordinates (x,y) of the vector refinement information include (0,0). However, transmission of the vector refinement information having the x and y coordinates (0,0) is redundant to reduce coding efficiency since it is identical to transmission of the motion vector information with the flag BLFlag set to 1 (S201).

### SUMMARY OF THE INVENTION

Therefore, the present invention has been made in view of the above problems, and it is an object of the present invention to provide a method for encoding video in a scalable fashion using motion vectors of a picture in the base layer, wherein values of vector refinement information required to use the base layer motion vectors are assigned in a manner ensuring a high coding efficiency, and a method for decoding a data stream of the enhanced layer encoded according to the decoding method.

In accordance with the present invention, the above and other objects can be accomplished by the provision of a method for encoding/decoding a video signal, wherein the video signal is encoded in a scalable MCTF scheme to output a bitstream of a first layer while the video signal is encoded in another specified scheme to output a bitstream of a second layer, and, when encoding is performed in the MCTF scheme, a value, which represents the difference between a position pointed to by a scaled motion vector obtained by scaling a motion vector of a first block included in the bitstream of the second layer by half of the ratio of a frame size of the first layer to a frame size of the second layer and a position pointed to by a motion vector of an image block in an arbitrary frame present in the first bitstream and temporally coincident with a frame including the first block, is selected from N values allocated respectively to N quarter-pixels surrounding the position pointed to by the scaled motion vector, and the selected value is recorded as vector refinement information of the image block.

In an embodiment of the present invention, a value is selected from 8 consecutive values allocated to positions of 8 quarter-pixels, which surround the position pointed to by the scaled motion vector, and the selected value is recorded as the vector refinement information.

In an embodiment of the present invention, the 8 consecutive values are assigned to the positions of the 8 quarter-pixels sequentially in clockwise direction of the positions thereof.

In an embodiment of the present invention, 3 bits are allocated and used to record the vector refinement information.

In an embodiment of the present invention, during decoding, a value of the vector refinement information is converted into coordinates, and the converted coordinates are added to the coordinates of a scaled vector of the motion vector of the first block to obtain a motion vector of the image block.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a procedure for encoding a picture in the enhanced layer using motion vectors of a temporally coincident picture in the base layer;

FIG. 2 illustrates how vector-related information is coded in the encoding procedure of FIG. 1;

FIG. 3 illustrates an example where a position pointed to by a motion vector of a target macroblock may be slightly different from that of a scaled motion vector of a corresponding block in the base layer by one quarter-pixel in the x or y axis;

FIG. 4 is a block diagram of a video signal encoding apparatus to which a video signal coding method according to the present invention is applied;

FIG. 5 illustrates main elements of an MCTF encoder in FIG. 4 responsible for performing image estimation/prediction and update operations;

FIG. 6 illustrates an example method for assigning values of vector refinement information required to use a scaled one of a motion vector in a base layer frame according to the present invention;

FIG. 7 is a block diagram of an apparatus for decoding a data stream encoded by the apparatus of FIG. 4; and

FIG. 8 illustrates main elements of an MCTF decoder in FIG. 7 responsible for performing inverse prediction and update operations.

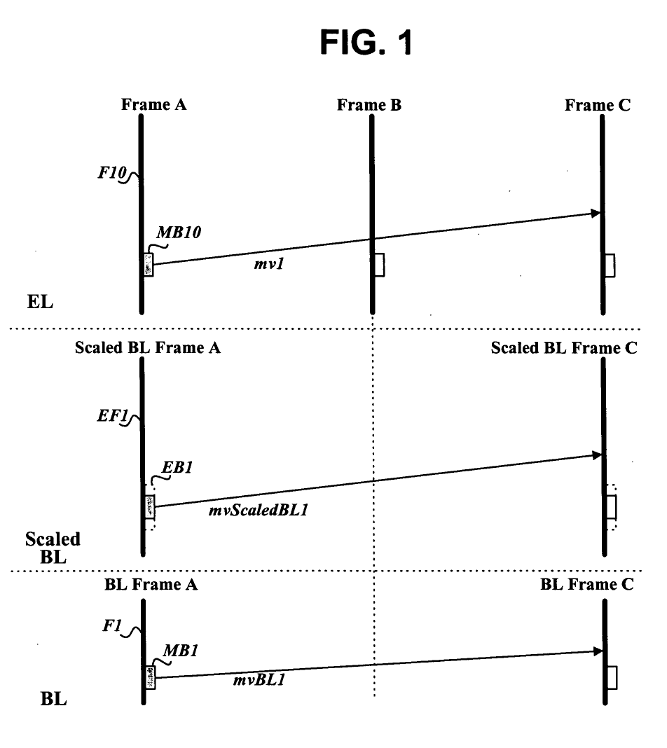

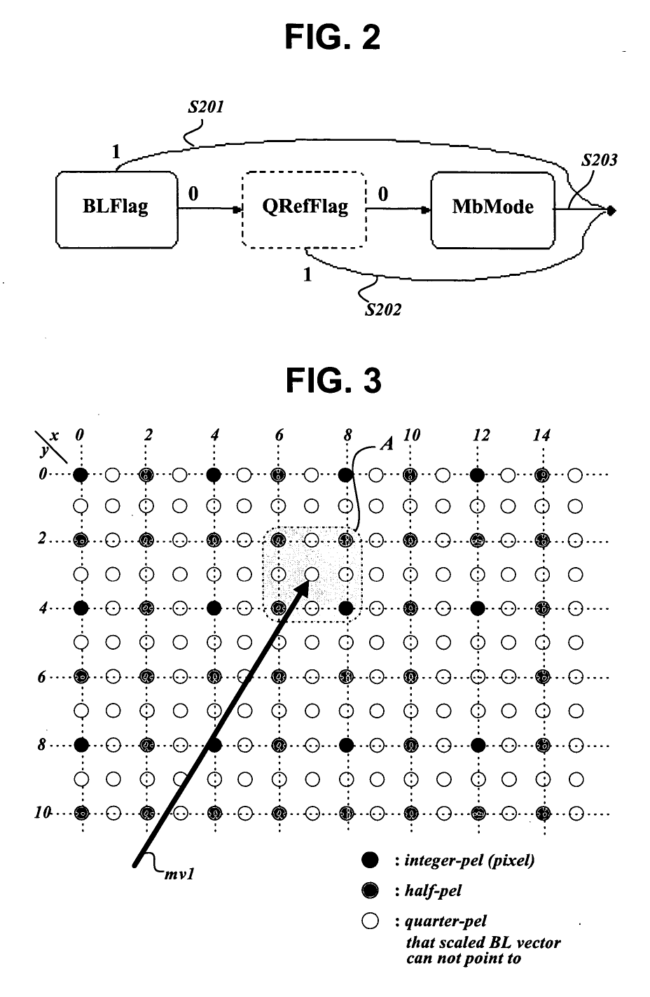

### DESCRIPTION OF THE PREFERRED EMBODIMENTS

Preferred embodiments of the present invention will now be described in detail with reference to the accompanying drawings.

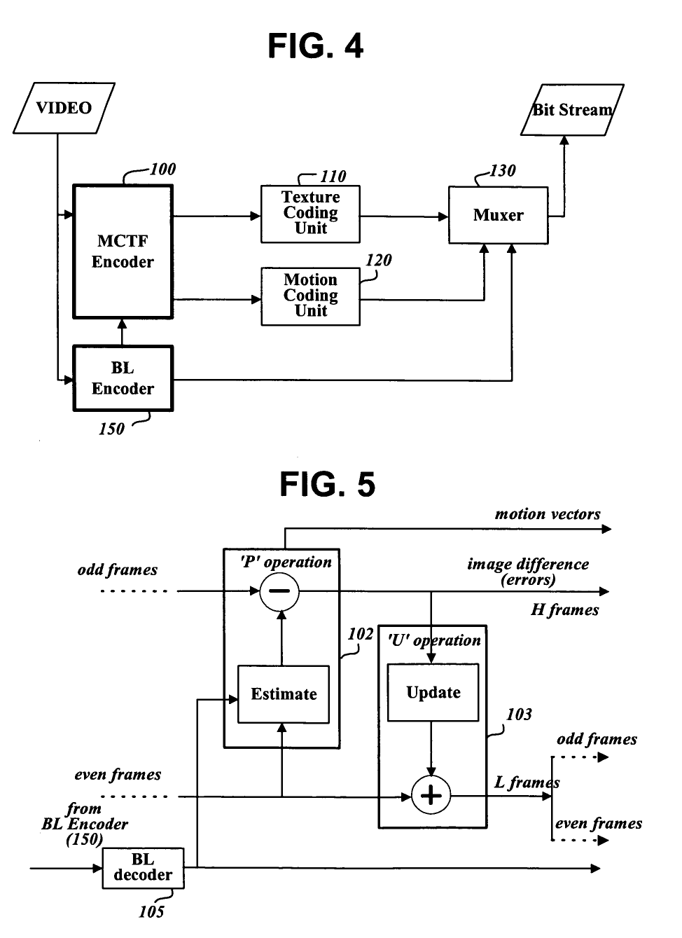

FIG. 4 is a block diagram of a video signal encoding apparatus to which a method for coding vector refinement information during scalable coding of a video signal according to the present invention is applied.

The video signal encoding apparatus shown in FIG. 4 comprises an MCTF encoder 100, a texture coding unit 110, a motion coding unit 120, a base layer encoder 150, and a muxer (or multiplexer) 130. The MCTF encoder 100 encodes an input video signal in units of macroblocks in an MCTF scheme, and generates suitable management information. The texture coding unit 110 converts information of encoded macroblocks into a compressed bitstream. The motion coding unit 120 codes motion vectors of image blocks obtained by the MCTF encoder 100 into a compressed bitstream according to a specified scheme. The base layer encoder 150 encodes an input video signal according to a specified scheme, for example, according to the MPEG-1, 2 or 4 standard or the H.261, H.263 or H.264 standard, and produces a small-screen picture sequence, for example, a sequence of pictures scaled down to 25% of their original size. The muxer 130 encapsulates the output data of the texture coding unit 110, the picture sequence output from the base layer encoder 150, and the output vector data of the motion coding unit 120 into a predetermined format. The muxer 130 then multiplexes and outputs the encapsulated data into a predetermined transmission format.

The MCTF encoder 100 performs motion estimation and prediction operations on each target macroblock in a video frame. The MCTF encoder 100 also performs an update operation on each target macroblock by adding an image difference of the target macroblock from a corresponding macroblock in a neighbor frame to the corresponding macroblock in the neighbor frame. FIG. 5 illustrates main elements of the MCTF encoder 100 for performing these operations.

The MCTF encoder 100 separates an input video frame sequence into odd and even frames and then performs estimation/prediction and update operations on a certain-length sequence of pictures, for example, on a Group Of Pictures (GOP), a plurality of times until the number of L frames, which are produced by the update operation, is reduced to one. FIG. 5 shows elements associated with estimation/prediction and update operations at one of a plurality of MCTF levels.

The elements of FIG. 5 include an estimator/predictor 102, an updater 103, and a base layer (BL) decoder 105. The BL decoder 105 functions to extract a motion vector of each motion-estimated (inter-frame mode) macroblock from a stream encoded by the base layer encoder 150 and also to scale up the motion vector of each motion-estimated macroblock by the upsampling ratio required to restore the sequence of small-screen pictures to their original image size. Through motion estimation, the estimator/predictor 102 searches for a reference block of each target macroblock of a current frame, which is to be coded to residual data, in a neighbor frame prior to or subsequent to the current frame, and codes an image difference (i.e., a pixel-to-pixel difference) of the target macroblock from the reference block. The estimator/predictor 102 directly calculates a motion vector of the target macroblock with respect to the reference block or generates information which uses a motion vector of a corresponding block scaled by the BL decoder 105. The updater 103 performs an update operation on a macroblock, whose reference block has been found by the motion estimation, by multiplying the image difference of the macroblock by an appropriate constant (for example, ½ or ¼) and adding the resulting value to the reference block. The operation carried out by the updater 103 is referred to as a ‘U’ operation, and a frame produced by the ‘U’ operation is referred to as an ‘L’ frame.

The estimator/predictor 102 and the updater 103 of FIG. 5 may perform their operations on a plurality of slices, which are produced by dividing a single frame, simultaneously and in parallel instead of performing their operations on the video frame. A frame (or slice) having an image difference (i.e., a predictive image), which is produced by the estimator/predictor 102, is referred to as an ‘H’ frame (or slice). The difference value data in the ‘H’ frame (or slice) reflects high frequency components of the video signal. In the following description of the embodiments, the term ‘frame’ is used in a broad sense to include a ‘slice’, provided that replacement of the term ‘frame’ with the term ‘slice’ is technically equivalent.

More specifically, the estimator/predictor 102 divides each of the input video frames (or each L frame obtained at the previous level) into macroblocks of a predetermined size. The estimator/predictor 102 codes each target macroblock of an input video frame through inter-frame motion estimation. The estimator/predictor 102 directly determines a motion vector of the target macroblock with respect to the reference block. Alternatively, if a temporally coincident frame is present in the enlarged base layer frames received from the BL decoder 105, the estimator/predictor 102 records, in an appropriate header area, information which allows the motion vector of the target macroblock to be determined using a motion vector of a corresponding block in the temporally coincident base layer frame. A video signal encoding method according to the present invention is described below in detail, focusing on how vector refinement information is coded when encoding the video signal using the motion vector in the corresponding block in the temporally coincident frame in the base layer.

For a target macroblock in the current frame which is to be coded into residual data, the estimator/predictor 102 searches for a reference macroblock most highly correlated with the target macroblock in adjacent frames prior to and/or subsequent to the current frame, and codes an image difference of the target macroblock from the reference macroblock into the target macroblock. Such an operation of the estimator/predictor 102 is referred to as a ‘P’ operation. The block most highly correlated with a target block is a block having the smallest image difference from the target block. The image difference of two image blocks is defined, for example, as the sum or average of pixel-to-pixel differences of the two image blocks. The block having the smallest image difference is referred to as a reference block. One reference block may be present in each of the reference frames and thus a plurality of reference blocks may be present for each target macroblock.

Then, the estimator/predictor 102 obtains a motion vector rmv originating from the current macroblock and extending to the reference block, and compares the obtained motion vector rmv with a scaled vector E_mvBL of a motion vector of a corresponding block in a predictive frame in the base layer, which is temporally coincident with the current frame. The corresponding block is a block in the predictive frame which would have an area covering a block at a position corresponding to the current macroblock if the predictive frame were enlarged to the same size of the enhanced layer frame. Each motion vector of the base layer is determined by the base layer encoder 150, and the motion vector is carried in a header of each macroblock and a frame rate is carried in a GOP header. The BL decoder 105 extracts necessary encoding information, which includes a frame time, a frame size, and a block mode and motion vector of each macroblock, from the header, without decoding the encoded video data, and provides the extracted information to the estimator/predictor 102. Before the extracted motion vector is provided to the estimator/predictor 102, it is scaled by half of the ratio of the screen size of the enhanced layer to the screen size of the base layer (i.e., each of the x and y components of the extracted motion vector is scaled up 200%).

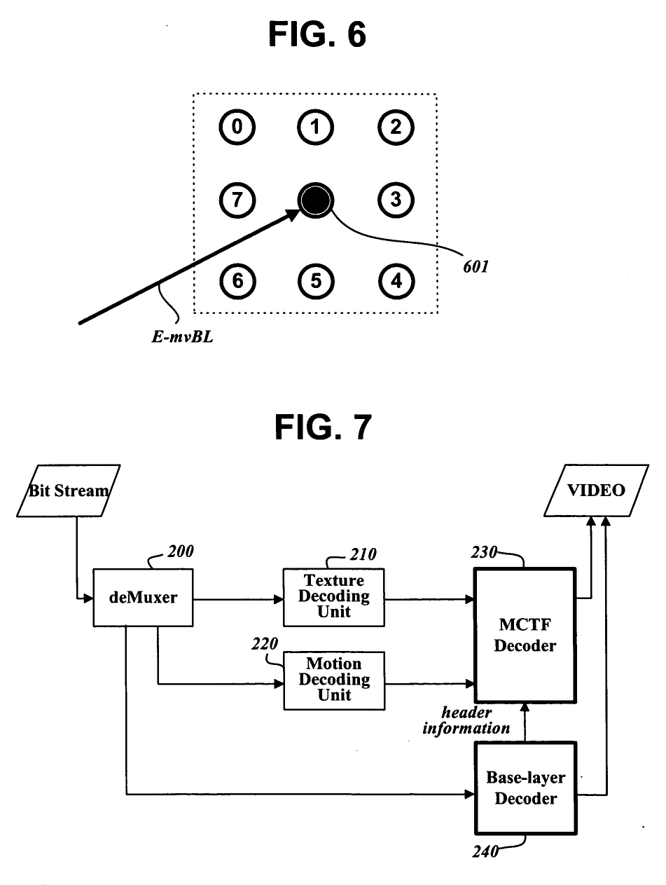

If the scaled motion vector E_mvBL of the corresponding block is identical to the vector rmv obtained for the current macroblock, the estimator/predictor 102 sets a flag BLFlag in a header of the current macroblock to “1”. If the difference between the two vectors E_mvBL and rmv is within the coverage of the vector refinement information (i.e., if each of the x and y components of the difference is not more than one quarter-pixel), the estimator/predictor 102 records refinement information which is assigned different values for positions (quarter-pixels) pointed to by the motion vector rmv, which are separated from a position pointed to by the scaled motion vector E_mvBL, as illustrated in FIG. 6. In this case, the flag BLFlag is set to 0 and a flag QrefFlag is set to 1.

The refinement information illustrated in FIG. 6 is assigned 8 different values for identifying 8 possible positions pointed to by the motion vector rmv of the current macroblock, which are one quarter-pixel or less away from a position 601 pointed to by the scaled motion vector E_mvBL of the corresponding block in the x or y direction, according to the present invention. For example, the vector refinement information is assigned a value of “0” for the upper left position pointed to by the motion vector rmv, a value of “1” for the upper middle position, a value of “2” for the upper right position, a value of “3” for the right middle position, a value of “4” for the lower right position, a value of “5” for the lower middle position, a value of “6” for the lower left position, and a value of “7” for the left middle position. The refinement information for the 8 positions pointed to by the motion vector rmv is assigned the 8 consecutive values “0” to “7” in clockwise order beginning with the upper left position. Of course, the refinement information for the 8 positions may also be assigned different values in a different manner. Accordingly, the estimator/predictor 102 selects one of the 8 possible values, which represents the end point of the difference vector (rmv−E_mvBL) between the motion vector rmv obtained for the current macroblock and the scaled motion vector E_mvBL, and records vector refinement information having the selected value.

According to the present invention, the vector refinement information is not expressed by a vector with x and y coordinates including (0,0) and, instead, has values assigned respectively to positions specified by the x and y coordinates other than (0,0) as described above, thereby reducing the amount of information to be transmitted.

For example, if the vector refinement information is transferred to and coded by a motion coding unit 120 at the next stage using a Fixed Length Code (FLC), the conventional method of expressing the refinement information using the x and y coordinates requires three values of +1, 0, and −1 for each of the x and y components, and thus assigns 2 bits to each of the x and y components and requires a total of 4 bits. However, the method of assigning 8 different values to the 8 positions according to the present invention requires only 3 bits, thereby reducing the amount of information to be transferred.

Also when the vector refinement information is coded using a variable length code (VLC), an arithmetic code, or a context adaptive binary arithmetic code (CABAC), the conventional method transfers information required to represent 9 different states, whereas the method according to the present invention transfers information required to represent 8 different states, thereby reducing the amount of coded information to be transferred.

Coding of the motion vector rmv of the current macroblock when the difference between the motion vector rmv and the scaled motion vector E_mvBL exceeds the coverage of the refinement information and when the current frame has no temporally coincident frame in the base layer may be performed in a known method, and a detailed description thereof is omitted since it is not directly related to the present invention.

A data stream including L and H frames encoded in the method described above is transmitted by wire or wirelessly to a decoding apparatus or is delivered via recording media. The decoding apparatus reconstructs the original video signal in the enhanced and/or base layer according to the method described below.

FIG. 7 is a block diagram of an apparatus for decoding a data stream encoded by the apparatus of FIG. 4. The decoding apparatus of FIG. 7 includes a demuxer (or demultiplexer) 200, a texture decoding unit 210, a motion decoding unit 220, an MCTF decoder 230, and a base layer decoder 240. The demuxer 200 separates a received data stream into a compressed motion vector stream, a compressed macroblock information stream, and a base layer stream. The texture decoding unit 210 reconstructs the compressed macroblock information stream to its original uncompressed state. The motion decoding unit 220 reconstructs the compressed motion vector stream to its original uncompressed state. The MCTF decoder 230 converts the uncompressed macroblock information stream and the uncompressed motion vector stream back to an original video signal according to an MCTF scheme. The base layer decoder 240 decodes the base layer stream according to a specified scheme, for example, according to the MPEG-4 or H.264 standard. The base layer decoder 240 not only decodes an input base layer stream but also provides header information in the stream to the MCTF decoder 230 to allow the MCTF decoder 230 to use necessary encoding information of the base layer, for example, information regarding the motion vector.

The MCTF decoder 230 includes a structure for reconstructing an input stream to an original video frame sequence.

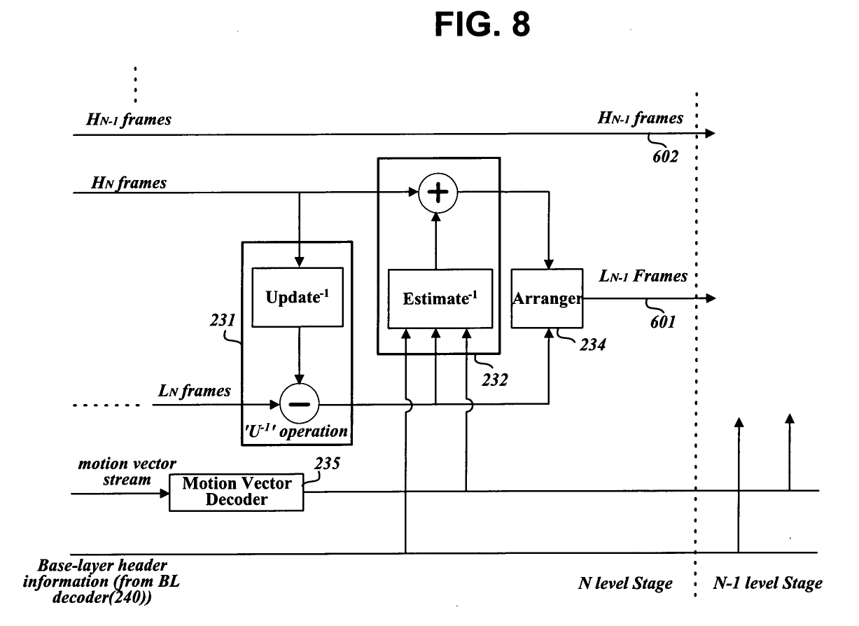

FIG. 8 illustrates main elements of the MCTF decoder 230 responsible for reconstructing a sequence of H and L frames of MCTF level N to an L frame sequence of MCTF level N−1. The elements of the MCTF decoder 230 shown in FIG. 8 include an inverse updater 231, an inverse predictor 232, a motion vector decoder 235, and an arranger 234. The inverse updater 231 subtracts pixel difference values of input H frames from corresponding pixel values of input L frames. The inverse predictor 232 reconstructs input H frames to L frames having original images using the H frames and the L frames, from which the image differences of the H frames have been subtracted. The motion vector decoder 235 decodes an input motion vector stream into motion vector information of macroblocks in H frames and provides the motion vector information to an inverse predictor (for example, the inverse predictor 232) of each stage. The arranger 234 interleaves the L frames completed by the inverse predictor 232 between the L frames output from the inverse updater 231, thereby producing a normal sequence of L frames.

L frames output from the arranger 234 constitute an L frame sequence 601 of level N−1. A next-stage inverse updater and predictor of level N−1 reconstructs the L frame sequence 601 and an input H frame sequence 602 of level N−1 to an L frame sequence. This decoding process is performed the same number of times as the number of MCTF levels employed in the encoding procedure, thereby reconstructing an original video frame sequence.

A more detailed description will now be given of how H frames of level N are reconstructed to L frames according to the present invention. First, for an input L frame, the inverse updater 231 subtracts error values (i.e., image differences) of macroblocks in all H frames, whose image differences have been obtained using blocks in the L frame as reference blocks, from the blocks of the L frame.

For each target macroblock of a current H frame, the inverse predictor 232 checks information regarding the motion vector of the target macroblock. If a flag BLFlag included in the information regarding the motion vector is 1, the inverse predictor 232 obtains a scaled motion vector E_mvBL by scaling a motion vector mvBL of a corresponding block in an H frame in the base layer temporally coincident with the current H frame by half of the ratio of the screen size of frames in the enhanced layer to the screen size of frames in the base layer, i.e., by scaling the x and y components of the motion vector mvBL up 200%. Then, the inverse predictor 232 regards the scaled motion vector E_mvBL as the motion vector of the target macroblock and specifies a reference block of the target macroblock using the scaled motion vector E_mvBL.

If the flag BLFlag is 0 and a flag QrefFlag is 1, the inverse predictor 232 confirms vector refinement information of the target macroblock provided from the motion vector decoder 235, and determines a compensation (or refinement) vector according to a position value included in the confirmed vector refinement information, and obtains an actual motion vector rmv of the target macroblock by adding the determined compensation vector to the scaled motion vector E_mvBL. When 8 position values “0” to “7” have been used to be assigned to the vector refinement information during encoding as illustrated in FIG. 6, the compensation vector is determined based on the position value in the vector refinement information such that a position value 0→a compensation vector (−1,1); 1→(0,1); 2→(1,1), 3→(1,0); 4→(1,−1); 5→(0,−1); 6→(−1,−1); and 7→(−1,0). When the actual motion vector rmv of the target macroblock is obtained in the above manner, the inverse predictor 232 specifies a reference block of the target macroblock by the obtained motion vector rmv.

If both the flags BLFlag and QrefFlag are 0, the inverse predictor 232 determines a motion vector of the target macroblock according to a known method and specifies a reference block of the target macroblock by the determined motion vector.

The inverse predictor 232 determines a reference block, present in an adjacent L frame, of the target macroblock of the current H frame with reference to the actual vector obtained from the base layer motion vector (optionally with the vector refinement information) or with reference to the directly coded actual motion vector, and reconstructs an original image of the target macroblock by adding pixel values of the reference block to difference values of pixels of the target macroblock. Such a procedure is performed for all macroblocks in the current H frame to reconstruct the current H frame to an L frame. The arranger 234 alternately arranges L frames reconstructed by the inverse predictor 232 and L frames updated by the inverse updater 231, and provides such arranged L frames to the next stage.

The above decoding method reconstructs an MCTF-encoded data stream to a complete video frame sequence or to a video frame sequence with a lower image quality and at a lower bitrate.

The decoding apparatus described above can be incorporated into a mobile communication terminal, a media player, or the like.

As is apparent from the above description, a method and apparatus for encoding and decoding a video signal according to the present invention uses vector refinement information, which can be expressed by a smaller number of different values, when coding a motion vector of a macroblock in the enhanced layer using a corresponding motion vector in the base layer, so that the amount of information regarding the motion vector is reduced, thereby improving the MCTF coding efficiency.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

What is claimed is:

1. A method for encoding an input video signal, the method comprising:
encoding the video signal in a first scheme and outputting a bitstream of a first layer; and
encoding the video signal in a second scheme and outputting a bitstream of a second layer including frames having a smaller screen size than frames in the bitstream of the first layer,
the encoding in the first scheme including a process for selecting a value from N values for vector refinement information representing the difference between a position pointed to by a scaled motion vector obtained by scaling a motion vector of a first block included in the bitstream of the second layer by half of the ratio of a frame size of the first layer to a frame size of the second layer and a position pointed to by a motion vector of an image block in an arbitrary frame present in the video signal and temporally coincident with a frame including the first block, and recording the vector refinement information including the selected value,
wherein the N values are assigned to respective positions of N quarter-pixels surrounding the position pointed to by the scaled motion vector.

2. The method according to claim 1, wherein the encoding in the first scheme further includes recording information, which indicates that the motion vector of the image block is to be obtained using both the scaled motion vector of the first block and the vector refinement information having a value selected from nonnegative integers, in a header of the image block.

3. The method according to claim 1, wherein the difference between the position pointed to by the scaled motion vector and the position pointed to by the motion vector of the image block is one quarter-pixel or less in vertical and horizontal directions of a frame.

4. The method according to claim 3, wherein N is equal to 8.

5. The method according to claim 4, wherein the 8 values are consecutive values assigned to the positions of the 8 quarter-pixels sequentially in clockwise order of the positions.

6. The method according to claim 1, wherein the ratio of the frame size of the first layer to the frame size of the second layer is 4.

7. A method for receiving and decoding an encoded bitstream of a first layer into a video signal, the method comprising:
decoding the bitstream of the first layer into video frames having original images according to a scalable scheme using encoding information including motion vector information, the encoding information being extracted and provided from an input bitstream of a second layer including frames having a smaller screen size than frames in the first layer,
decoding the bitstream of the first layer into the video frames including a process for scaling a motion vector, included in the encoding information, of a first block in a frame present in the bitstream of the second layer and temporally coincident with an arbitrary frame including a target block in the bitstream of the first layer by half of the ratio of a frame size of the first layer to a frame size of the second layer, and obtaining a motion vector of the target block from the scaled motion vector and vector refinement information of the target block,
wherein the vector refinement information has a value selected from N values assigned to respective positions of N quarter-pixels surrounding a specific quarter-pixel.

8. The method according to claim 7, wherein the process includes obtaining the motion vector of the target block based on both the scaled motion vector and the vector refinement information if information regarding the target block included in the bitstream of the first layer is set to indicate use of the vector refinement information.

9. The method according to claim 7, wherein the process includes obtaining the motion vector of the target block by converting a value of the vector refinement information selected from nonnegative integers into x and y coordinates according to a predetermined manner and adding x and y components of the x and y coordinates to x and y components of the scaled motion vector.

10. The method according to claim 9, wherein the converted x and y coordinates are given relative to a position of the specific quarter-pixel.

11. The method according to claim 10, wherein the converted x and y coordinates are one of (−1,1), (0,1), (1,1), (1,0), (1,−1), (0,−1), (−1,−1), and (−1,0).

12. The method according to claim 11, wherein a unit of each of the converted x and y coordinates corresponds to a quarter-pixel.

13. The method according to claim 7, wherein N is equal to 8.

14. The method according to claim 7, wherein the ratio of the frame size of the first layer to the frame size of the second layer is 4.
